(19) United States
(12) Patent Application Publication
(10) Pub. No.: US 2003/0183467 A1
(43) Pub. Date: Oct. 2, 2003

(54) Placement of an auxilliary mass damper to eliminate torsional resonances in driving range in a parallel-series hybrid system

(75) Inventor: Shailesh S. Kozarekar, Novi, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 10/063,196

(22) Filed: Mar. 28, 2002

(51) Int. Cl. F16F 7/10

(52) U.S. Cl. 188/380

(57) ABSTRACT

A damper system for hybrid vehicles powered by an internal combustion engine and an electrical motor, and the damper system is located between the gear system and the electrical motor. The damper system connects the electrical motor to a hub ring attached to a pair of cover plates, which are separated by a plurality of spacer bolts. A flange, which is placed between the cover plates, connects to a shaft attached to the gear system via another hub ring. The flange has a plurality of windows for locating coil springs. The inertia of the electrical motor is linked to the inertia of the gear system through the coil springs.

### BACKGROUND OF INVENTION

1. Field of the Invention

The present invention is in the field of automotive, specifically in the area of vibration in an automobile, and more specifically in the area of vibration in a parallel-series hybrid vehicle.

2. Background of the Invention

Torsional resonance vibration has always been an inherent problem with automobiles powered by an internal combustion engine because of repetitive and alternate engine strokes. Several methods have been devised to minimize this vibration, and they usually involve adding a damper system, which uses an additional mass to absorb the vibration forces.

The added mass minimizes the vibration but also adds extra weight to the automobiles. The extra weight from the traditional damper system affects the automobile's performance and adds to the complexity of automobiles.

The torsional resonance vibration is diminished in hybrid vehicles that are powered by an internal combustion engine and an electrical motor, but it is not eliminated. By tradition, the vibration problem in a hybrid vehicle has been dealt with in the same way as in an internal combustion engine vehicle, i.e., adding an extra mass to absorb vibration forces, even though the hybrid vehicle is built quite differently from a gas powered automobile. To better understand the uniqueness of a hybrid vehicle, it will be generally described in the concept and the construction of a hybrid vehicle.

Generally, a hybrid electric vehicle combines electric propulsion with traditional internal combustion engine propulsion to achieve enhanced fuel economy and/or lower exhaust emissions. Electric propulsion has typically been generated through the use of batteries and electric motors. Such an electric propulsion system provides the desirable characteristics of high torque at low speeds, high efficiency, and the opportunity to regeneratively capture otherwise lost braking energy. Propulsion from an internal combustion engine provides high energy density, and enjoys an existing infrastructure and lower costs due to economics of scale. By combining the two propulsive systems with a proper control strategy, the result is a reduction in the use of each device in its less efficient range. Furthermore, regarding a parallel hybrid configuration, the combination of a downsized engine with an electric propulsion system into a minimal hybrid electric vehicle results in a better utilization of the engine, which improves fuel consumption. Furthermore, the electric motor and battery can compensate for reduction in the engine size.

In typical configurations, the combination of the two types of propulsion systems (internal combustion and electric) is usually characterized as either series or parallel hybrid systems. In a pure series hybrid propulsion system, only the electric motor(s) is in direct connection with the drive train and the engine is used to generate electricity that is fed to the electric motor(s). The advantage of this type of system is that the engine can be controlled independently of driving conditions and can therefore be consistently run in its optimum efficiency and low emission ranges. A key disadvantage to the series arrangement is the loss in energy experienced because of the inefficiencies associated with full conversion of the engine output to electricity.

In a pure parallel hybrid propulsion system, both the engine and the electric motor (s) are directly connected to the drive train and either one may independently drive the vehicle. Because there is a direct mechanical connection between the engine and the drive train in a parallel hybrid propulsion system, less energy is lost through conversion to electricity compared to a series of hybrid propulsion systems. The operating point for the engine, however, cannot always be chosen with full freedom.

The two hybrid propulsion systems can be combined into either a switching hybrid propulsion system or a parallel-series hybrid propulsion system. A switching hybrid propulsion system typically includes an engine, a generator, a motor, and a clutch. The engine is typically connected to the generator. The generator is connected through a clutch to the drive train. The motor is connected to the drive train between the clutch and the drive train. The clutch can be operated to allow series or parallel hybrid propulsion.

A parallel-series hybrid system, as is exemplary employed with respect to the present invention, includes an engine, a generator, and a motor. The planetary gear set allows a series path from the engine to the generator and a parallel path from the engine directly to the drive train. In a parallel-series hybrid system, the engine speed can be controlled by way of the series path, while maintaining the mechanical connection between the engine and drive train through the parallel path. The motor augments the engine on the parallel path in a similar manner as a traction motor in a pure parallel hybrid propulsion system, and provides an opportunity to use energy directly through the series path, thereby reducing the losses associated with converting the electrical energy into and out of chemical energy from the battery.

In a typical parallel-series hybrid system, the generator is connected to the sun gear of the planetary gear set. The engine is connected to the planetary carrier and the output gears (usually including an output shaft and gears for interconnection with the motor and the wheel-powering, final drive train) are connected to the ring gear. In such a configuration, the parallel-series hybrid system generally operates in four different modes; one electric mode and three hybrid modes.

In the electric mode, the parallel-series hybrid system propels the vehicle utilizing only stored electrical energy and the engine is turned off. The tractive torque is supplied from the motor, the generator, or a combination of both. This is the preferred mode when the desired power is low enough that it can be produced more efficiently by the electrical system than by the engine and when the battery is sufficiently charged. This is also a preferred mode for reverse driving because the engine cannot provide reverse torque to the power train in this configuration.

In the parallel hybrid mode, the engine is operating and the generator is locked. By doing this, a fixed relationship between the speed of the engine and the vehicle speed is established. The motor operates as either a motor to provide tractive torque to supplement the engine's power, or can be operated to produce electricity as a generator. This is a preferred mode whenever the required power demand requires engine operation and the required driving power is approximately equal to an optimized operating condition of the engine. This mode is especially suitable for cruising speeds exclusively maintainable by the small internal combustion engine fitted to the hybrid electric vehicle.

In a parallel-series split hybrid mode, the engine is on and its power is divided between a direct mechanical path to the drive train and an electrical path through the generator. The engine speed in this mode is typically higher than the engine speed in the parallel mode, thus deriving higher engine power. The electrical energy produced by the generator can flow to the battery for storage or to the motor for immediate utilization. In the positive parallel-series mode, the motor can be operated as either a motor to provide tractive torque to supplement the engine's power or to produce electricity supplementally with the generator. This is the preferred mode whenever high engine power is required for tractive powering of the vehicle, such as when high magnitude acceleration is called for, as in passing or uphill ascents. This is also a preferred mode when the battery is charging.

In a negative parallel-series hybrid mode, the engine is in operation and the generator is being used as a motor against the engine to reduce its speed. Consequently, engine speed, and therefore engine power, is lower than in parallel mode. If needed, the motor can also be operated to provide tractive torque to the drive train or to generate electricity therefrom. This mode is typically never preferred due to increased losses at the generator and planetary gear system, but will be utilized when engine power is required to be decreased below that which would otherwise be produced in parallel mode. This situation will typically be brought about because the battery is in a well-charged condition and/or there is low tractive power demand. In this regard, whether operating as a generator or motor, the torque output of the generator is always of the same sense (+/−); that is, having a torque that is always directionally opposed to that of the engine. The sign of the speed of the generator, however, alternates between negative and positive values depending upon the direction of rotation of its rotary shaft, which corresponds with generator versus motor modes. Because power is dependent upon the sense of the speed (torque remains of the same sense), the power will be considered to be positive when the generator is acting as a generator and negative when the generator is acting as a motor.

When desiring to slow the speed of the engine, the current being supplied to the generator is changed causing the speed of the generator to slow. Through the planetary gear set, this in turn slows the engine. This effect is accomplished because the resistive force acting against the torque of the generator is less at the engine than at the drive shaft, which is connected to the wheels and is being influenced by the entire mass of the vehicle. It should be appreciated that the change in speed of the generator is not equal, but instead proportional to that of the engine because of gear ratios involved within the connection therebetween.

Typically, to achieve a smooth engine start in hybrid electric vehicles in which the engine is mechanically interconnected with the drive wheels, the start of engine fuel injection and ignition are made at revolutionary speeds above any mechanical resonance speeds of the drive train. Additionally, at full take-off acceleration, any delay in the engine's production of power typically decreases engine performance. Still further, to achieve smooth driving characteristics and obtain low fuel consumption, the engine torque and speed change rates must be limited. At full take-off, this usually results in an increased time for the engine to reach maximum power, and all of these conditions deteriorate acceleration performance of the vehicle.

As can be appreciated, the engine is not always running during vehicle operation. If the engine is stopped for a sufficiently long period during the operation of the vehicle, the exhaust system catalyst may cool down too much, and to such a degree, that a temporary, but significant increase in exhaust emissions occur upon restart and until the catalyst once again warms to its effective temperature.

In a typical parallel-series hybrid electric propulsion arrangement, the control strategy advantageously involves operating the engine along optimum efficiency torque versus speed curves. A trade-off exists between traction force performance and fuel economy that, for optimization, typically requires selection of a particular gear ratio between the engine and the wheels that causes the engine to deliver more power than is needed for vehicle propulsion. This generally occurs at cruising in parallel mode, or near constant vehicle velocity conditions. Operation under these conditions can sometimes cause the battery and charging system to reject energy being presented thereto from the engine. This problem is generally solved by decreasing or limiting the engine output power by entering negative split mode that entails using the generator as a motor to control the engine to a decreased speed. Such control allows the engine to follow an optimum curve at reduced engine output power.

Use of the generator as a motor gives rise to a power circulation in the power train, which leads to undesirable energy losses at the generator, motor, inverters and/or planetary gear set. These energy losses may be manifest as heat generation, which indicates that most efficient use is not being made of the installed drive train.

In a parallel-series hybrid propulsion system having planetary gear set(s) and utilizing a generator lock-up device, harshness in ride occurs when the generator lock-up device is engaged or released. This is due primarily to the difference in how the engine torque is estimated when the vehicle is in different operating modes. Typically, when the generator is locked-up, engine torque is estimated from the combustion control process of the engine. When the generator is free, as in a parallel-series mode, however engine torque is estimated from the generator torque control process. The difference in values of these two estimating techniques gives rise to what usually amounts to a variation in operating torque between the engine and generator when the lock-up device is engaged or disengaged, thereby creating harshness in the vehicle's operation, usually manifest as abrupt changes or jerkiness in the vehicle's ride.

The generator is typically used to control the engine in parallel-series hybrid mode. This is usually accomplished by employing a generator having maximum torque capabilities substantially greater than the engine's maximum torque that is transmittable to the planetary gear system. Failure to have such a control margin can result in generator over-speed and possible damage to the propulsion system. Such a control margin means, however, that the engine and generator are not fully exploited at full capacity acceleration.

There are several deficiencies associated with the use of known hybrid electric vehicle designs described hereinabove, and one of them is related to torsional resonance vibrations.

Torsional vibration is caused, among other factors, by the unevenness of the crankshaft rotation of an internal combustion engine and the consequential rotation of the drive train. The torsional vibration may comprise an entire spectrum of vibrations of different frequencies and may resonate with the natural frequency of the body of a vehicle. The torsional resonance vibrations that are in driving range create a vibration or a noise that is objectionable to drivers and passengers.

One way to move these resonance vibrations out of the critical driving range is the use of an auxiliary damper usually located on the drive shaft, which is commonly known as Prop-Shaft Damper. This auxiliary damper comprises a torsional spring and a mass and can be tuned to a specific frequency. This combination of torsional springs and masses adds weight to a vehicle and increases its cost. The added weight has a direct impact on the fuel consumption, because the heavier a vehicle is more fuel needed to move it.

The additional weight is especially undesirable in hybrid vehicles because of limited power provided by the electrical motor. Hybrid vehicles, under current technology, tend to be less heavy when compared to a vehicle propelled by a traditional internal combustion engine, so the hybrid vehicles can have a better performance with an electrical motor. Any additional weight will affect this performance objective.

Therefore, a better solution to this torsional resonance vibration is clearly needed.

### SUMMARY OF INVENTION

Briefly described, the present invention is an auxiliary damper system for hybrid vehicles. The auxiliary damper system according to the present invention replaces the traditional spring-mass combination damper system installed along a drive shaft with a system installed adjacent to an electrical motor and employs no additional mass. The auxiliary damper system employs inertia of an electrical motor in combination with springs to reduce the torsional resonance vibration.

The auxiliary damper system according to the present invention eliminates the traditional spring-mass damper system in the drive shaft and places a spring-motor-inertia damper system adjacent to the electrical motor, also known as traction motor, of a hybrid vehicle. The spring-motor-inertia damper system is preferably placed between the differential gear and the gear system and adjacent to the electrical motor. The electrical motor provides necessary inertia for the spring-motor-inertia damper system.

The electrical motor is connected to two cover plates that are separated from each other by several spacer bolts. The motor connected to the cover plates through a hub and splines in a construction similar to a clutch disc. The cover plates have indentations for holding coil springs. A flange is placed between two cover plates and attached through a hub and splines to a shaft that is connected to a transmission shaft. The motor inertia is not directly linked to gear inertias but through several coil springs that are less stiff than the shaft.

The spring-motor-inertia system can be tuned to the natural frequency of the vehicle The tuning is done by adjusting the spring rate By adjusting the spring rate the natural frequency of the combination spring-motor-inertia can be placed within the driving range. The inertia created can counteract the torsional resonance vibration in the driving range and greatly reducing the vibration.

### BRIEF DESCRIPTION OF DRAWINGS

The foregoing and other aspects and advantages of the invention described herein will be better understood from the following detailed description of one or more preferred embodiments of the invention with reference to the drawings in which:

FIG. 1 is a perspective view of a hybrid electric vehicle showing exemplary system component locations on the vehicle.

FIG. 2 is a schematic depicting the architecture of a parallel-series hybrid electric vehicle.

FIG. 3 is a cross-sectional schematic representation of a planetary gear set.

FIG. 4 is a simplified schematic view of a one-way clutch shown in FIG. 1.

FIG. 5 illustrates a schematic of a traditional spring-mass damper system.

FIG. 6 depicts a schematic of a spring-inertia damper system according to the present invention.

### DETAILED DESCRIPTION

As required, detailed embodiments of the present invention are disclosed herein. However, it is understood that the disclosed embodiments are merely exemplary of the invention(s) that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Referring now in greater detail to the drawings, in which like numerals represent like components throughout several views, FIG. 1 depict an electric/hybrid electric transporting vehicle 10 is shown having a power train system included therein for providing propulsion, as well as serving supplemental functions which are described in greater detail herein. With respect to hybrid electric vehicles, the power train system is predominantly positioned in an engine room 11 located near a passenger compartment 12 of the vehicle 10. A battery compartment or housing 14, also positioned near the passenger compartment 12 holds one or more batteries 410.

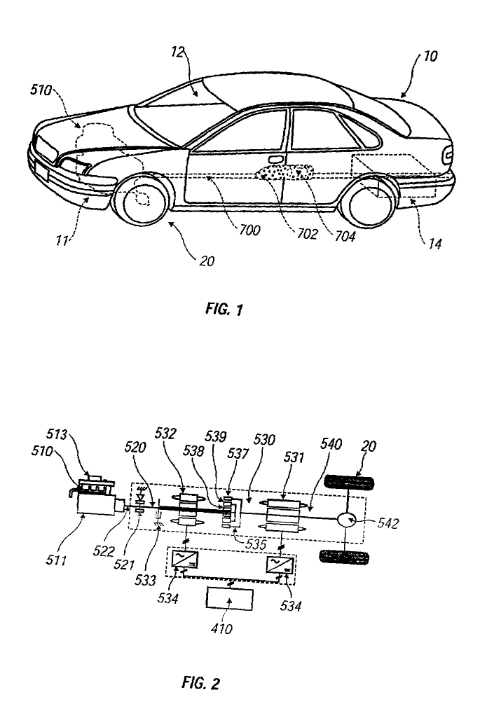

As depicted in FIG. 2, the overall systems architecture of the electric hybrid vehicle 10 comprises an engine system 510, including an internal combustion engine 511 (gasoline, diesel or the like) that is mechanically connected by an output shaft system 520 to a transaxle system 530. The transaxle system 530 is further connected to a drive shaft system 540 utilized to rotate one or more drive wheels 20 that propel the hybrid electric transporting vehicle 10. In an embodiment, the combustion engine 511 is controlled by an engine control module (ECM) or unit 513 that is capable of adjusting, among possible parameters, airflow to, fuel flow to and/or ignition at the engine 511. The engine 511 is mechanically connected via an output shaft 522 to the transaxle system 530. A planetary gear set 535 establishes interconnection between the engine 511 (via the output shaft 522), a generator 532, and the drive shaft system 540 (via the transaxle system 530). A motor 531 is also coupled to the drive shaft system 540, also possibly via the transaxle system 530.

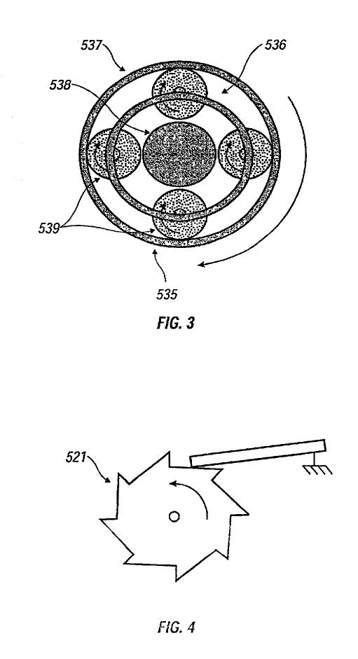

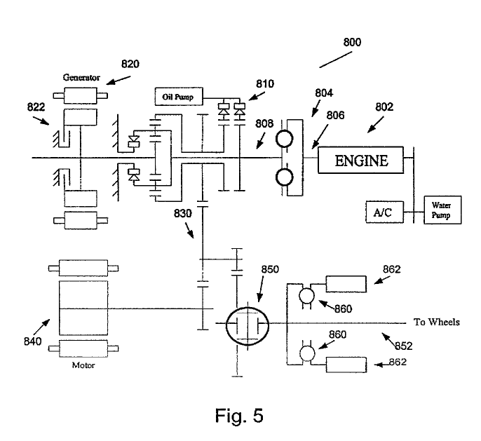

In one embodiment, and which is illustrated in at least FIGS. 3 and 5, a one-way clutch 521 is engageable with the output shaft 522, which in turn is connected to the engine 511 and to the planetary gear set 535. The function of the one-way clutch 521 is to limit the engine being only a power/torque input to the planetary gear set 535, and with only one direction of rotation. Consequently, the one-way clutch 521 prevents power or torque from being transmitted from the planetary gear set 535 back to the engine 511.

In another aspect, and as shown in FIG. 3, the planetary gear set 535 comprises a plurality of concentrically positioned planet gears 539 mechanically engaged between a perimeter region of a centrally located sun gear 538 and an interior surface of a ring gear 537. The individual gears that make up the plurality or set of planet gears 539 are fixed in positions relative to each other by a planetary carrier 536.

The generator 532 is mechanically connected to the sun gear 538 and is configured to convey rotational power and torque to and from the planetary gear set 535. In an embodiment, the generator 532 is capable of being locked to prevent rotation of the sun gear 538 by a generator brake or lock-up device 533. The motor 531 is mechanically connected to the ring gear 537 and is configured to convey rotational power and torque to and from the planetary gear set 535. In an embodiment, and as schematically shown in FIG. 2, the drive shaft system 540 is engageable with the motor 531 and effectively terminates at the drive wheel 20, via what can be a conventionally configured transmission/differential arrangement 542.

FIG. 5 depicts a schematic of a traditional spring-mass damper system 800. The schematic is for a hybrid vehicle powered by an internal combustion engine 802 and an electrical motor 840. The engine's 802 crankshaft 806 is coupled to a main shaft 808 (also known as an output shaft) through a flywheel 804, and the main shaft 808 is further coupled to a gear system 810, which includes, among others, a planetary gear set.

A generator 820 is also coupled to the main shaft 808. The generator 820 has a lock-up device 822, which can lock-up the generator 820 during the steady state driving to reduce power consumption by the generator 820. The steady state driving is when the vehicle moves at a relatively steady speed and the power from the engine 802 is transferred to the planetary gear set in the gear system 810 to a transmission counter gear 830 to a differential gear 850, and then to a drive shaft 852.

The system 800 is susceptible to torsional resonance vibrations. The torsional resonance vibrations are caused mainly by the unevenness of the crankshaft 806 rotation. This vibration affects the entire drive train, from the main shaft 808 to the gear system 810, to the transmission axle 830, to the differential gear 850, and to the drive shaft 852. The transmission axle 830 rattling is made noticeable when the electrical motor 840 is not under any kind of load, and this rattling is added to the vibration and transmitted to the body of the automobile. Often these vibrations and rattlings appear in the frequency that falls within the driving range especially for front wheel drive vehicles. The differential gear can also rattle for those rear wheel drive vehicles.

The critical frequency for hybrid vehicles may lie around 1500 rpm (rotation per minute), which is the range of operation for the hybrid vehicles in hybrid operation when the engine 802 operates at the low speed and high torque condition. In this operating mode, the torsional resonance vibrations are more critical.

Traditionally, a spring-mass damper system composed of springs 860 and masses 862 is placed along the drive shaft 852 to eliminate torsional resonance vibrations. The spring-mass system can be tuned to the natural frequency of the system to absorb the vibration energy on the transmission axle 830 and the drive shaft 852, and consequently the energy transferred to the wheels and to the body of the vehicle decreases. The tuning is accomplished through adjusting one or more of the masses, the spring rate, and/or the friction. The additional masses and springs increase the weight and the cost of the vehicle.

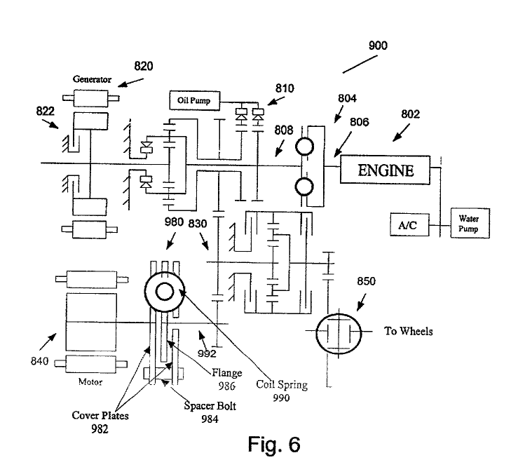

FIG. 6 illustrates a system 900 according to the present invention. It is illustrated in FIG. 6 a parallel hybrid vehicle with an electrical motor 840, where the motor inertia is attached to a damper instead of a transmission axle 830. A parallel hybrid vehicle has a gasoline engine 802 and an electrical motor 840 and both the engine 802 and the electrical motor 840 can turn the transmission, which in turn moves the wheels. The electrical motor 840 is a mass that hangs off the transmission axle 830 that can be utilized to damper the torsional resonance vibrations. A damper system 980 according to the present invention is introduced between the electrical motor 840 and the transmission axle 830. The damper system 980 comprises two cover plates 982 separated by a plurality of spacer bolts 984. The electrical motor 840 is connected through a hub ring and splines to the cover plates. A flange 986 is placed between the cover plates 982 and the flange 986 connects through another hub ring and splines to a shaft 992, which is connected to the transmission axle 830. The coil springs facilitate the relative movement between the flange and the cover plates. The coil springs 990 in the damper system 980 can be steel coil spring or a rubber spring among other possibilities.

The spring-inertia damper system 980 is placed adjacent to the electrical motor 840 and utilizes the inertia and the friction of the electrical motor 840 to absorb vibration energy. The damper rate can be tuned to the vehicle's critical frequency and the damper capacity needs to be more than the electrical motor's torque.

The cover plates 982 generally have indentations for holding the coil springs 990, and the flange 986 has windows for locating the coil springs 990.

The engagement of the motor 840 to the damper system 980 is similar to a clutch, and this engagement removes the direct connection between the inertia from the electrical motor 840 and the inertias from the gear system and the engine. Now, the inertia from the gear system and the engine is coupled to the electrical motor's inertia via the coil springs 990, which are less stiff than a shaft from the electrical motor 840.

The damper system 980 provides additional mass through the electrical motor 840 and yet interfaces through less stiff members, i.e. coil springs 990, which lowers the natural frequency to within the driving range.

Changing spring rate, which is also known as hysteresis, can adjust the natural frequency for the damper system 980. In an alternate embodiment, the damper system 980 may be placed in different locations, such as adjacent to the transmission, the differential, or the drive shaft. Generally, a preferred location is immediately downstream from the electrical motor.

The foregoing description of preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application to enable others skilled in the art to utilize the invention and various embodiments and with various modifications as are suited to the particular use contemplated.

1. A damper system for hybrid vehicles comprising:
an electrical motor connected to a first hub ring;
a plurality of cover plates separated by a plurality of spacer bolts, the plurality of cover plates being connected to the first hub ring;
a flange having a plurality of windows, wherein the flange is placed between the plurality of cover plates; and
a plurality of spring elements, wherein each spring element is located inside each window in the flange.

2. The damper system of claim 1, wherein the damper system is placed immediately downstream from a hybrid vehicle's gear system.

3. The damper system of claim 1, wherein the damper system is placed between a gear system and a differential gear.

4. The damper system of claim 1, wherein the plurality of spring elements are coil springs.

5. The damper system of claim 4, wherein the coil springs are made from steel.

6. The damper system of claim 4, wherein the coil springs are made from rubber.

7. The damper system of claim 1, wherein the flange is connected to a second hub ring, the second hub ring being connected to a shaft.
